(19) United States
(12) Patent Application Publication
(10) Pub. No.: US 2008/0019845 A1
(43) Pub. Date: Jan. 24, 2008

(54) Fluid Pressure Motor

(75) Inventors: Kenji Suzuki, Tokyo (JP); Takafumi Akutagawa, Tokyo (JP); Hiroaki Kuboi, Tokyo (JP)

Correspondence Address: RABIN & Berdo, PC, 1101 14TH STREET, NW, SUITE 500, WASHINGTON, DC, 20005, US

(73) Assignee: Kayaba Industry Co., Ltd., Tokyo (JP)

(21) Appl. No.: 11/793,354

(22) PCT Filed: Dec. 14, 2005
(86) PCT No.: PCT/JP05/23426

§ 371 Date: Jun. 14, 2007

(30) Foreign Application Priority Data
Dec. 17, 2004 (JP) 2004-365972

(51) Int. Cl. F03C 1/253

(52) U.S. Cl. 417/270; 91/500

(57) ABSTRACT

In a swash plate piston motor (2), a piston (24, 41) which is caused to reciprocate by a fluid pressure and a cylinder block (23) which rotates within an operating chamber (21) in accordance with the reciprocation of the piston (24, 41) are accommodated in the operating chamber (21) inside a case (30). When the cylinder block (23) rotates through inertia after a supply of working fluid to a working fluid passage (11, 12) for applying the fluid pressure to the piston (24, 41) has been shut off, a check valve (18) supplies working fluid in the operating chamber (21) to the working fluid passage (11, 12) through a communicating passage (14) if necessary. As a result, the interior pressure of the fluid pressure motor (2) is prevented from becoming negative, and the piston (24, 41) is prevented from floating up from a swash plate (25).

### TECHNICAL FIELD

This invention relates to a fluid passage of a fluid pressure motor that rotates an output shaft using a reciprocating piston.

### BACKGROUND OF THE INVENTION

To stop an operation of a fluid pressure motor that uses a reciprocating piston, a supply passage for supplying a fluid to the fluid pressure motor and a discharge passage for discharging the fluid from the fluid pressure motor are both shut off. However, due to inertia, the motor does not stop rotating immediately, and as a result, the pressure in a fluid chamber of a cylinder during an expansion operation of the piston, or in other words a gradually enlarged fluid chamber, becomes negative. This negative pressure leads to phenomena such as surging, which are undesirable in terms of the durability of the fluid pressure motor.

Japanese Patent Serial No. 2880758, published by the Japan Patent Office in 1999, discloses a fluid pressure circuit in which fluid is supplied rapidly to a negative pressure fluid chamber of a cylinder using a drain to connect a high pressure charge passage to a supply passage and a discharge passage for supplying and discharging fluid to the fluid pressure motor via a check valve.

### DISCLOSURE OF THE INVENTION

In the prior art, when fluid is supplied to the enlarged fluid chamber of the cylinder from the charge passage via the check valve and the fluid passages, a momentary delay may occur in the supply of fluid to the fluid chamber due to pressure loss in the piping and other passages.

This momentary delay in the supply of fluid to the fluid chamber causes a temporary loss of the force required to push a piston or a shoe against a swash plate. As a result, the piston or shoe may float upward so as to become unable to follow the swash plate, making a smooth operation of the piston difficult. Such a situation is undesirable in terms of the durability of the fluid pressure motor.

One method of maintaining the ability of the piston or shoe to follow the swash plate involves increasing the spring load of a spring which biases the piston toward the swash plate. However, increasing the spring load leads to a reduction in torque efficiency and mechanical efficiency during start-up of the fluid pressure motor.

It is therefore an object of this invention to prevent a piston or a shoe from floating up during inertial rotation of a fluid pressure motor using a reciprocating piston, regardless of the spring load of a spring.

In order to achieve this object, this invention provides a fluid pressure motor comprising, a piston which is caused to reciprocate by a fluid pressure, an operating chamber, a cylinder block which rotates within the operating chamber in accordance with a reciprocation of the piston, a working fluid passage which applies the fluid pressure to the piston, a communicating passage which connects the operating chamber to the working fluid passage, and a check valve provided in the communicating passage. The check valve permits a working fluid to flow only from the operating chamber to the working fluid passage.

The details as well as other features and advantages of this invention are set forth in the remainder of the specification and are shown in the accompanying drawings.

### BRIEF DESCRIPTION OF THE DRAWINGS

FIG. 1 is a fluid pressure circuit diagram of a motor/brake unit employing a fluid pressure motor according to this invention.

FIG. 2 is a longitudinal sectional view of the fluid pressure motor.

FIG. 3 is a fluid pressure circuit diagram of the motor/brake unit, illustrating the flow of a working fluid during a steady state operation of the fluid pressure motor.

FIG. 4 is a longitudinal sectional view of the main parts of the fluid pressure motor, illustrating the flow of the working fluid during a steady state operation of the fluid pressure motor.

FIG. 5 is a fluid pressure circuit diagram of the motor/brake unit, illustrating the flow of the working fluid during inertial rotation of the fluid pressure motor.

FIG. 6 is a longitudinal sectional view of the main parts of the fluid pressure motor, illustrating the flow of the working fluid during an inertial operation of the fluid pressure motor.

FIG. 7 is a longitudinal sectional view of the main parts of the fluid pressure motor, illustrating another embodiment relating to a piston and a swash plate.

### DESCRIPTION OF THE PREFERRED EMBODIMENTS

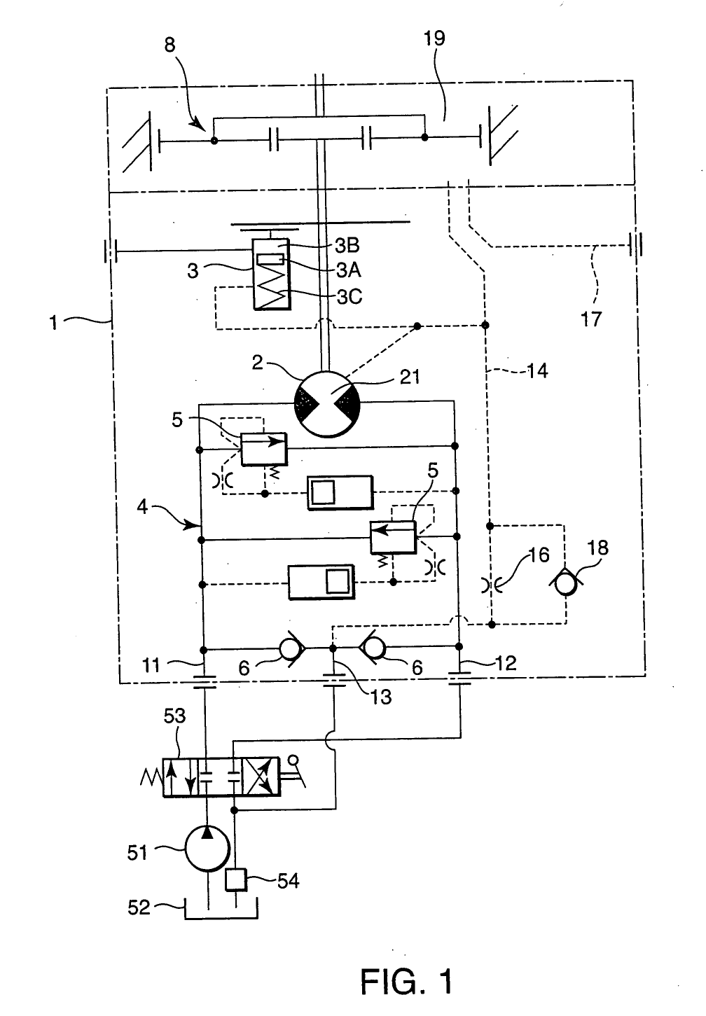

Referring to FIG. 1 of the drawings, a motor/brake unit 1 for driving a swivel base of a construction machine such as a power shovel comprises a fluid pressure motor 2, a fluid pressure releasing brake 3, a fluid pressure circuit relating thereto, and a gear mechanism 8.

The fluid pressure motor 2 is joined to the swivel base, not shown in the drawing, via the gear mechanism 8. The gear mechanism 8 is accommodated in a gear chamber 19 formed inside the unit 1.

The fluid pressure motor 2 comprises two ports for supplying and discharging a working fluid reversibly. A fluid pressure motor drive circuit 4 for driving the fluid pressure motor 2 comprises two working fluid passages 11 and 12 which are connected to the two ports. The fluid pressure motor 2 is rotated by the fluid pressure of the working fluid that is caused to flow through the fluid pressure motor 2 by the working fluid passages 11 and 12.

The working fluid passages 11 and 12 are connected to a fluid pressure pump 51 and a reservoir 52 provided on the outside of the unit 1 via a direction switching valve 53. The fluid pressure pump 51 aspirates working fluid from the reservoir 52, pressurizes the aspirated working fluid, and supplies the pressurized working fluid to the working fluid passage 11 or 12 via the direction switching valve 53. Thus, the fluid pressure motor 2 is driven to rotate in a rotation direction corresponding to the passage to which the working fluid is supplied.

The working fluid passages 11 and 12 are connected to each other via a pair of pilot pressure-sensitive relief valves 5. One of the pilot pressure-sensitive relief valves 5 causes the working fluid in the working fluid passage 11 to flow out to the working fluid passage 12 in accordance with high pressure in the working fluid passage 11. The other pilot pressure-sensitive relief valve 5 causes the working fluid in the working fluid passage 12 to flow out to the working fluid passage 11 in accordance with high pressure in the working fluid passage 12.

The working fluid that is discharged from the motor/brake unit 1 via one of the working fluid passages 11 and 12 passes through a filter 54 and then flows into the reservoir 52.

The fluid pressure motor drive circuit 4 also comprises a charge passage 13 that guides the working fluid flowing into the reservoir 52 from the upstream side of the filter 54, and a drain passage 17 that communicates with the reservoir 52. The charge passage 13 is maintained at a predetermined pressure which is slightly higher than a drain pressure of the drain passage 17. Here, the predetermined pressure is set at 0.1-0.3 megapascals (MPa) higher than the drain pressure.

The charge passage 13 is connected to the working fluid passages 11 and 12 via respective check valves 6. These check valves 6 allow the working fluid to flow from the charge passage 13 into the working fluid passages 11 and 12, and prevent backflow of the working fluid.

Hence, when the pressure of either of the working fluid passages 11 and 12 decreases during inertial rotation of the fluid pressure motor 2 occurring after an operation thereof is stopped, as described above, the working fluid in the charge circuit 13 is supplied to the reduced-pressure working fluid passage 11 or 12 via the check valve 6. This supply of working fluid serves to prevent cavitation from occurring in the fluid pressure motor 2.

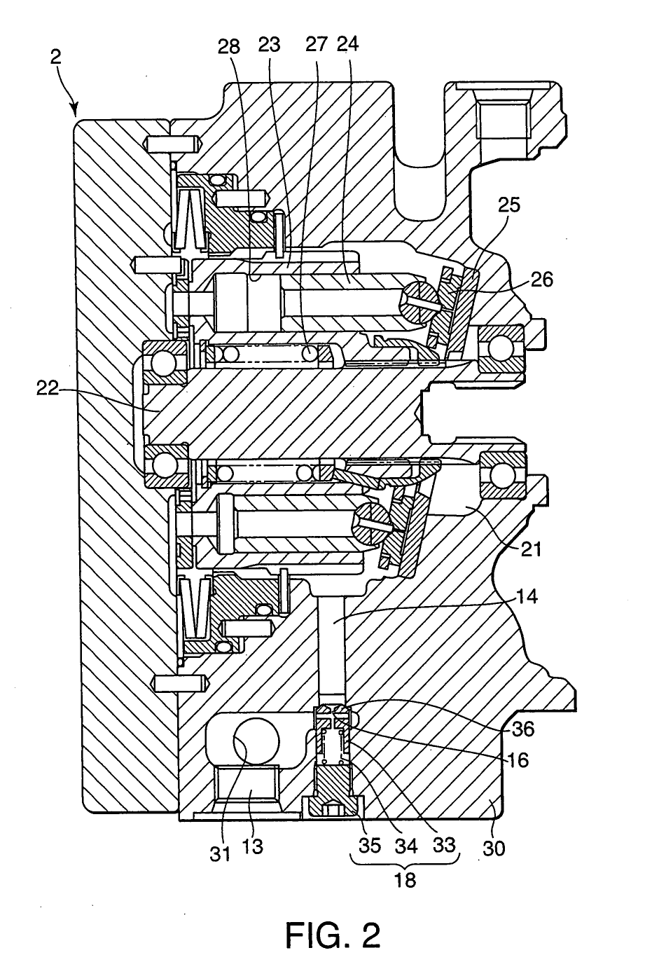

Referring to FIG. 2, the fluid pressure motor 2 is a swash plate piston motor, and comprises a cylinder block 23 fixed to an output shaft 22, and a swash plate 25 fixed to a case 30 at an incline relative to the output shaft 22.

The cylinder block 23 comprises a plurality of cylinders 28 disposed at equal angular intervals on the circumference. A piston 24 is accommodated in each cylinder 28. A shoe 26 is joined to the tip end of each piston 24. The shoe 26 is maintained in a state of sliding contact with the swash plate 25 by a spring 27. Pressurized working fluid is supplied to each cylinder 28 in a predetermined rotation position from the working fluid passage 11 (12) to cause the piston 24 to expand. As the piston 24 expands, the shoe 26 slides over the swash plate 25, and as a result, the cylinder block 23 rotates and the output shaft 22 formed integrally with the cylinder block 23 also rotates. A piston 24 positioned symmetrically to the expanding piston 24 is pressed against the swash plate 25 so as to contract, and as a result, working fluid is discharged from the cylinder 28 into the working fluid passage 12 (11).

The cylinder block 23 is accommodated in an operating chamber 21 inside a case 30. The operating chamber 21 communicates with a communicating passage 14 formed in the case 30. Meanwhile, the charge passage 13 is led into the case 30 from the outside. The pair of check valves 6 shown in FIG. 1 are provided in the case 30. The case 30 is formed with a through hole 31 connecting the charge passage 13 to the check valves 6.

The communicating passage 14 and the charge passage 13 are connected via a check valve 18 provided in the interior of the case 30.

The check valve 18 comprises a seat portion 36 facing the communicating passage 14, a valve body 33 which is seated on the valve seat 36 relative to the communicating passage 14, a spring 34 which biases the valve body 33 toward the valve seat 36, and a plug 35 which supports the spring 34. When the valve body 33 is caused to retreat from the valve seat 36 by the pressure of the communicating passage 14, the communicating passage 14 communicates with the charge passage 13.

Meanwhile, an orifice 16 is formed in the valve body 33. The orifice 16 connects the communicating passage 14 to the charge passage 13 even when the valve body 33 is seated on the valve seat 36, thereby permitting the passage of a small amount of working fluid between these passages. By forming the orifice 16 in the valve body 33 of the check valve 18, the construction of the case 30 can be made simpler than that of a case in which the orifice 16 is provided in the case 30 independently of the check valve 18.

Returning to FIG. 1, the communicating passage 14 communicating with the operating chamber 21 of the fluid pressure motor 2 therefore communicates with the charge passage 13 via the charge passage 13, the check valve 18, and the orifice 16, which are disposed in parallel.

The fluid pressure releasing brake 3 maintains the swivel base in an ordinary braked state using a brake member biased by a spring 3C via a piston 3A. On the other hand, when fluid pressure supplied to a brake release pressure chamber 3B from the outside causes the piston 3A to retreat together with the brake member against the spring 3C, the swivel base 9 is released from the braked state. A spring chamber 3D housing the spring 3C communicates with the communicating passage 14.

The communicating passage 14 also communicates with the gear chamber 19 to supply a lubricating working fluid to the gear chamber 19. Having lubricated the gear chamber 19, the working fluid is discharged to the drain 17.

When the pressurized working fluid is supplied to the working fluid passage 11 (12) to cause the swivel base to swivel, the piston 24 is pushed out from the cylinder 28 such that the shoe 26 on the tip end of the piston 24 rotates relative to the swash plate 25, and thus the cylinder block 23 is driven to rotate. The rotation of the cylinder block 23 is transmitted to the swivel base from the output shaft 22 via the gear mechanism 8, thereby causing the swivel base to swivel. After reaching a maximum expansion position, the piston 24 is pushed back into the cylinder 28 as the shoe 26 rotates relative to the swash plate 25, and thus the working fluid is discharged to the working fluid passage 12 (11) from the cylinder 28. This working fluid flows into the reservoir 52 via the filter 54, but a part of the working fluid is supplied to the charge passage 13 upstream of the filter 54.

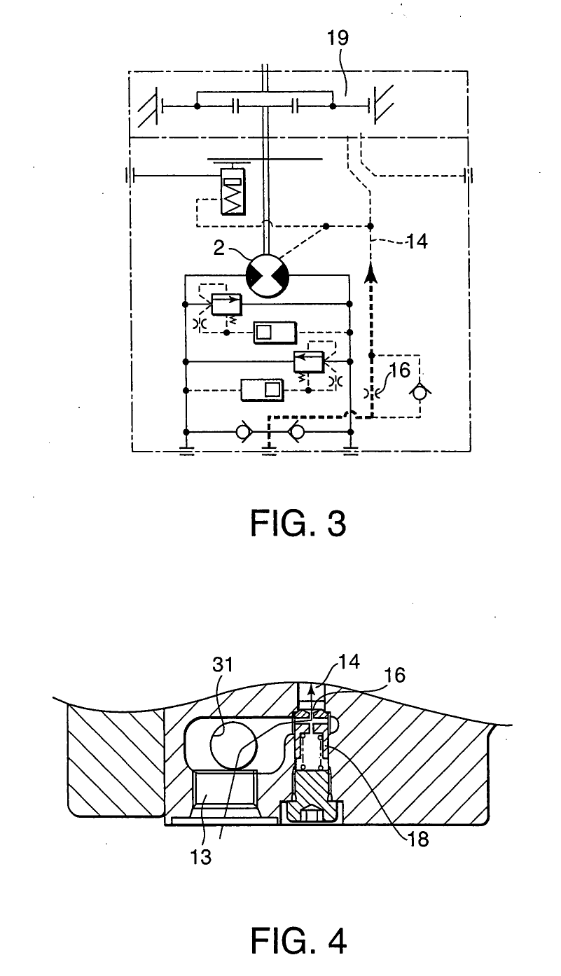

Normally, the charge passage 13 communicates with the communicating passage 14 via the orifice 16. Hence, when the operating chamber 21 of the fluid pressure motor 2 or the spring chamber 3D of the fluid pressure brake 3 are lacking in working fluid during a normal operation of the fluid pressure motor 2, the working fluid in the charge passage 13 is supplied to the operating chamber 21 or the spring chamber 3D via the orifice 16, as shown in FIGS. 3 and 4. The working fluid for lubricating the gear chamber 19 is also supplied from the charge passage 13 via the orifice 16.

When the direction switching valve 53 is switched to a neutral position for shutting off the passage of working fluid through the working fluid passages 11 and 12 to stop the swivel base swiveling, the supply of working fluid to the fluid pressure motor 2 is halted. However, the fluid pressure motor 2 attempts to continue to rotate due to inertial force. As a result, a part of the cylinders 28 decreases in pressure, leading to a reduction in the pressure of the working fluid passage 11 (12) that is connected to the reduced-pressure cylinder 28.

By having working fluid flow into the working fluid passage 11 (12) from the charge passage 13 via the check valve 6 at this time, the pressure in the working fluid passage 11 (12) and the interior of the cylinder 28 in the fluid pressure motor 2 is prevented from becoming negative. This operation is identical to the prior art.

The charge passage 13 is led into the casing 30 of the fluid pressure motor 2 from the outside of the motor/brake unit 1, and therefore has a long passage length. Hence, when pressure loss occurs at a point in the charge passage 13 in response to a momentary pressure reduction in the working fluid passage 11 (12), a delay is likely to occur during working fluid replenishment. When replenishment is performed using working fluid from the charge passage 13 alone and the pressure in the cylinder 28 decreases, the shoe 26 cannot be kept in sliding contact with the swash plate 25 by the spring load of the spring 27 alone, and therefore, the shoe 26 may float up from the swash plate 25.

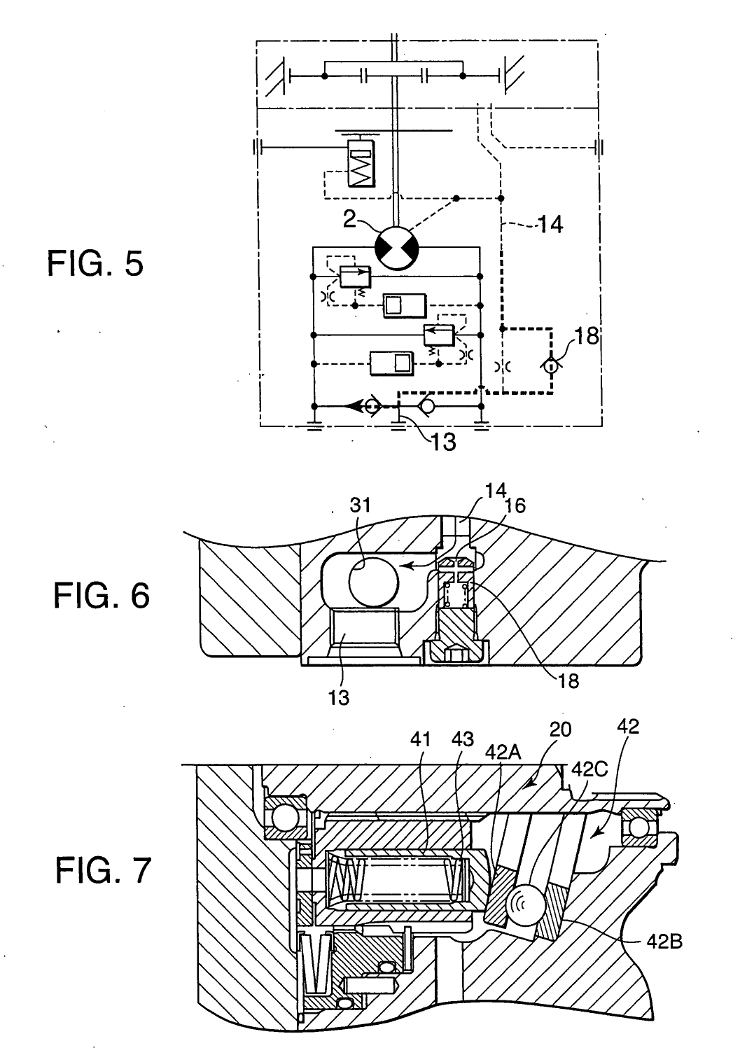

However, according to this invention, when the pressure of the cylinder 28 decreases momentarily, the check valve 18 opens such that the working fluid in the operating chamber 21 of the fluid pressure motor 2 is supplied to the charge passage 13 immediately through the communicating passage 14, as shown in FIGS. 5 and 6, and this working fluid passes through the through hole 31 and check valve 6 from the charge passage 13 so as to be supplied from the working fluid passage 11 (12) to the cylinder 28.

The operating chamber 21, communicating passage 14, through hole 31, and check valve 6 are all provided inside the casing 30, and only the parts of the charge passage 13 and working fluid passage 11 (12) that are provided in the interior of the casing 30 are used in the working fluid supply route described above.

In other words, the working fluid only moves through passages provided inside the casing 30 when the reduced-pressure cylinder 28 is replenished with working fluid from the operating chamber 21. Hence, in comparison with a case such as that of the prior art, in which the reduced-pressure cylinder 28 is replenished with working fluid from the outside of the motor/brake unit 1 via the charge passage 13, the working fluid passage length can be shortened, thereby creating an environment in which the pressure of the cylinder 28 is less likely to decrease.

Therefore, the shoe 26 can be prevented from floating up from the swash plate 25 without increasing the spring load of the spring 27.

In the embodiment described above, the piston 24 slides over the swash plate 25 via the shoe 26. FIG. 7 shows another embodiment relating to the construction of this part.

Here, the tip end of a hollow piston 41 contacts a swash plate 42 directly, and a spring 43 for biasing the piston 41 toward the swash plate 42 is accommodated inside the cylinder 28. The swash plate 42 comprises two disks 42A, 42B that rotate relative to each other via a ball bearing 42C, and the piston 41, which contacts one of the disks 42A, causes the disk 42A to rotate relative to the disk 42B. The invention may also be applied to this type of fluid pressure motor.

The contents of Tokugan 2004-365972, with a filing date of Dec. 17, 2004 in Japan, are hereby incorporated by reference.

Although the invention has been described above with reference to certain embodiments of the invention, the invention is not limited to the embodiments described above. Modifications and variations of the embodiments described above will occur to those skilled in the art, within the scope of the claims.

For example, the embodiments described above relate to a swash plate piston motor, but this invention may be applied to other types of piston motor. A choke may be used instead of the orifice 16. A claimed flow passage sectional area reducing mechanism refers to both an orifice and a choke.

In the embodiments described above, the working fluid passage 11 corresponds to a claimed first working fluid passage, and the working fluid passage 12 corresponds to a second working fluid passage.

In the embodiments described above, the check valve 18 corresponds to a claimed first check valve, and the check valve 6 corresponds to a claimed second check valve.

### INDUSTRIAL APPLICABILITY

As described above, in this invention, a cylinder reduced in pressure by an inertial force during a stoppage of a fluid pressure motor employing a reciprocating piston is replenished with a working fluid from an operating chamber via a check valve, and therefore floating up of the piston or a shoe due to the pressure reduction in the cylinder can be prevented, regardless of a spring load of a spring. Accordingly, this invention exhibits a particularly desirable effect when applied to a fluid pressure motor used to drive a swivel base of a construction machine.

The embodiments of this invention in which an exclusive property or privilege is claimed are defined as follows:

1. A fluid pressure motor comprising:
a piston which is caused to reciprocate by a fluid pressure;
an operating chamber;
a cylinder block which rotates within the operating chamber in accordance with a reciprocation of the piston;
a working fluid passage which applies the fluid pressure to the piston;
a communicating passage which connects the operating chamber and the working fluid passage; and
a check valve provided in the communicating passage, the check valve permitting a working fluid to flow only from the operating chamber to the working fluid passage.

2. The fluid pressure motor as defined in claim 1, further comprising a case, wherein the operating chamber and the communicating passage are formed in the case.

3. The fluid pressure motor as defined in claim 1, further comprising a flow passage sectional area reducing mechanism provided in the communicating passage parallel with the check valve.

4. The fluid pressure motor as defined in claim 3, wherein the check valve comprises a valve body that is lifted in accordance with a pressure of the operating chamber, and the flow passage sectional area reducing mechanism is constituted by a hole portion that penetrates the valve body.

5. The fluid pressure motor as defined in claim 1, further comprising a charge passage which charges the working fluid into the working fluid passage, and a second check valve which connects the charge passage and the working fluid passage, the second check valve permitting the working fluid to flow only from the charge passage to the working fluid passage, wherein the communicating passage is connected to the charge passage upstream of the second check valve.

6. The fluid pressure motor as defined in claim 5, wherein the working fluid passage comprises a first working fluid passage which applies a fluid pressure for rotating the cylinder block in a predetermined direction to the piston, and a second working fluid passage which applies a fluid pressure for rotating the cylinder block in an opposite direction to the predetermined direction to the piston, and the second check valve comprises a check valve which connects the charge passage to the first working fluid passage, and a check valve which connects the charge passage to the second working fluid passage.

7. The fluid pressure motor as defined in claim 6, wherein the first working fluid passage and the second working fluid passage are connected to a fluid pressure pump and a reservoir on an outside of the case via a direction switching valve.

8. The fluid pressure motor as defined in claim 7, wherein the direction switching valve and the reservoir are connected via a filter, and the working fluid that reaches the filter is led to the charge passage from the direction switching valve.

9. The fluid pressure motor as defined in claim 2, further comprising a swash plate fixed in an interior of the case, wherein the cylinder block comprises a plurality of cylinders disposed at equal angular intervals in a rotation direction, the piston being accommodated in each cylinder, and the fluid pressure motor includes a swash plate piston motor in which the piston is caused to rotate relative to the swash plate by applying the fluid pressure of the working fluid passage to the piston in the cylinder.

10. The fluid pressure motor as defined in claim 4, further comprising a charge passage which charges the working fluid into the working fluid passage, and a second check valve which connects the charge passage and the working fluid passage, the second check valve permitting the working fluid to flow only from the charge passage to the working fluid passage, wherein the communicating passage is connected to the charge passage upstream of the second check valve.

11. The fluid pressure motor as defined in claim 3, further comprising a charge passage which charges the working fluid into the working fluid passage, and a second check valve which connects the charge passage and the working fluid passage, the second check valve permitting the working fluid to flow only from the charge passage to the working fluid passage, wherein the communicating passage is connected to the charge passage upstream of the second check valve.

12. The fluid pressure motor as defined in claim 2, further comprising a flow passage sectional area reducing mechanism provided in the communicating passage parallel with the check valve.

13. The fluid pressure motor as defined in claim 12, further comprising a charge passage which charges the working fluid into the working fluid passage, and a second check valve which connects the charge passage and the working fluid passage, the second check valve permitting the working fluid to flow only from the charge passage to the working fluid passage, wherein the communicating passage is connected to the charge passage upstream of the second check valve.

14. The fluid pressure motor as defined in claim 2, further comprising a charge passage which charges the working fluid into the working fluid passage, and a second check valve which connects the charge passage and the working fluid passage, the second check valve permitting the working fluid to flow only from the charge passage to the working fluid passage, wherein the communicating passage is connected to the charge passage upstream of the second check valve.
